(19) United States
(12) Patent Application Publication
(10) Pub. No.: US 2023/0093859 A1
(43) Pub. Date: Mar. 30, 2023

(54) INFORMATION PROCESSING DEVICE AND INFORMATION PROCESSING METHOD

(71) Applicant: TOSHIBA TEC KABUSHIKI KAISHA, Tokyo (JP)

(72) Inventor: Atsushi Nakanishi, Chofu Tokyo (JP)

(21) Appl. No.: 17/846,068

(22) Filed: Jun. 22, 2022

(30) Foreign Application Priority Data
Sep. 27, 2021 (JP) 2021-156639

(51) Int. Cl. G06Q 10/02; G06Q 50/12; G06Q 20/20

(52) U.S. Cl. CPC G06Q 10/02; G06Q 50/12; G06Q 20/20

(57) ABSTRACT

According to one embodiment, an information processing device includes: a setting unit configured to set a last order time on a per group basis, a group being formed by one or more customers; a notification unit configured to notify a terminal device used by staff of seating information that can specify a table occupied by the group whose remaining time to the last order time is shorter than a predetermined threshold; and a clearing unit configured to accept a clearing of the notification by the notification unit, from the terminal device.

### CROSS-REFERENCE TO RELATED APPLICATION

This application is based upon and claims the benefit of priority from Japanese Patent Application No. 2021-156639, filed on Sep. 27, 2021, the entire contents of which are incorporated herein by reference.

### FIELD

Embodiments described herein relate generally to an information processing device and an information processing method.

### BACKGROUND

According to the related art, a system for managing an all-you-can-eat or all-you-can-drink setting at a restaurant is proposed. In many cases, a time limit is provided for an all-you-can-drink menu or an all-you-can-eat menu (hereinafter also referred to as an all-you-can menu), for example, such that the all-you-can menu is valid for two hours from the first order.

Also, many restaurants have a last order system. The last order time is, for example, about 30 minutes before the closing time. As the last order time approaches, the staff goes around to each table and informs the customers that the last order time is approaching. At this point, the customers can place the last order.

A similar last order is applied to the time of expiration of the time limit for the all-you-can menu. For example, a customer whose time limit expires at 20:30 is informed of that at around 20:00 and the customer's last order for the all-you-can menu is accepted.

With respect to the last order for the all-you-can menu as described above, the related-art system presents an estimated time or the like but does not actively support the staff to take the last order or the like. Therefore, there is some room for improvement.

### DESCRIPTION OF THE DRAWINGS

FIG. 1 shows an example of the configuration of an order management system according to a first embodiment.

FIG. 2 shows an example of the hardware configuration of a handheld terminal.

FIG. 3 shows an example of the hardware configuration of an order management device.

FIG. 4 shows an example of information stored in a last order time management file.

FIG. 5 shows an example of information stored in an all-you-can time management file.

FIG. 6 is a block diagram showing an example of functional units provided in a control unit of the order management device.

FIG. 7 shows an example of a notification screen displaying a list of last order advice targets.

FIG. 8 shows an example of a seating information screen displayed by a display unit of the handheld terminal.

FIG. 9 shows an example of a seating information screen displayed by a display unit of POS terminal.

FIG. 10 shows an example of a notification screen displayed at a self-service ordering terminal.

FIG. 11 is a flowchart explaining an example of a flow of processing executed by the control unit as a setting unit.

FIG. 12 is a flowchart explaining an example of a flow of processing executed by the control unit as a notification unit and a clearing unit.

### DETAILED DESCRIPTION

An embodiment described herein is to provide an information processing device and an information processing method that enable support for taking the last order or the like.

In general, according to one embodiment, an information processing device includes: a setting unit configured to set a last order time on a per group basis, a group being formed by one or more customers; a notification unit configured to notify a terminal device used by staff of seating information that can specify a table occupied by the group whose remaining time to the last order time is shorter than a predetermined threshold; and a clearing unit configured to accept a clearing of the notification by the notification unit, from the terminal device.

### First Embodiment

An order management system according to a first embodiment will now be described with reference to the drawings. In the embodiment described below, an example of an order management system introduced in a shop (restaurant) such as a Japanese bar is described. However, the present disclosure is not limited to this embodiment.

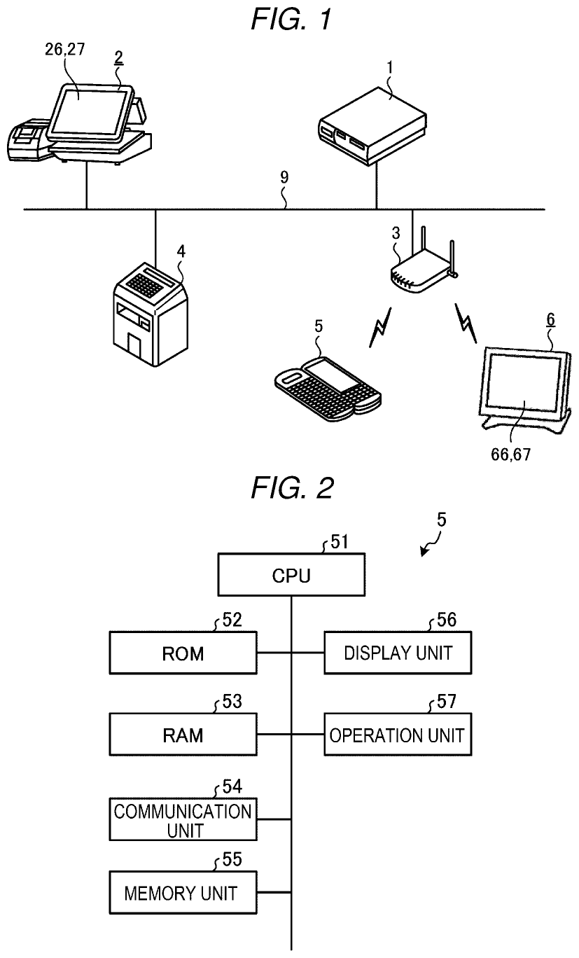

FIG. 1 shows an example of the configuration of the order management system according to the embodiment. As shown in FIG. 1, the order management system has an order management device 1, a POS (point of sales) terminal 2, an access point 3 for wireless communication, a kitchen printer 4, a handheld terminal 5, and a self-service ordering terminal 6. In FIG. 1, one handheld terminal 5 and one self-service ordering terminal 6 are shown. However, the order management system may include a plurality of handheld terminals 5 and a plurality of self-service ordering terminals 6.

The order management device 1, the POS terminal 2, the access point 3, and the kitchen printer 4 are wired together via a network 9 such as a LAN (local area network) provided in the shop. The access point 3 is installed, for example, at the ceiling, wall surface or the like of the shop. The handheld terminal 5 and the self-service ordering terminal 6 can connect to the network 9 via wireless communication and the access point 3.

The order management device 1 is installed at a back office or the like of the shop. The order management device 1 may also be referred to as an ordering station or the like and is a server that controls the entirety of the order management system. The order management device 1 manages order data received from the handheld terminal 5 or the self-service ordering terminal 6 and transmits and outputs various data to each device in the order management system.

For example, the order management device 1 outputs order data received from the handheld terminal 5 or the self-service ordering terminal 6 to the kitchen printer 4. The order management device 1 also generates slip data based on the order data received from the handheld terminal 5 or the self-service ordering terminal 6. The slip data is assigned a slip number corresponding to a set of one or more order data. On receiving a slip data transmission request from the POS terminal 2, the order management device 1 transmits the slip data to the POS terminal 2 in response to the request.

The order management device 1 sets and manages a last order time on a per table number basis, based on the order data received from the handheld terminal 5 or the self-service ordering terminal 6. The last order means the final order placed by a customer. The last order time means the time when the customer is advised about the last order.

For example, the last order time can be set to be a time point that is a predetermined time (for example, 30 minutes) before the closing time of the shop. In the case of a menu such as an all-you-can-drink menu or an all-you-can-eat menu (hereinafter also referred to as an all-you-can menu) provided at a restaurant such as a Japanese bar, it is common that a time limit is provided. In this embodiment, if an item from the all-you-can menu is ordered, the last order time is set to be a time point that is a predetermined time (for example, 30 minutes) before the end time of the all-you-can menu.

When the last order time comes, the order management device 1 reports the corresponding table number to the handheld terminal 5 or reports the last order to the self-service ordering terminal 6 of the corresponding table number. If a predetermined operation is executed at the handheld terminal 5 or the self-service ordering terminal 6, the order management device 1 executes update processing in which the table number for which the advice about the last order is completed is defined as being already advised.

The handheld terminal 5 is an example of a terminal device used by the staff and is held by a staff member who is an attendant (floor attendant). The handheld terminal 5 is a terminal device used by the staff and functions as an order input device that generates order data. When a customer visits the shop, the staff guides the customer to a vacant table and inputs the table number of the table and the number of people seated at the table, to the handheld terminal 5. The handheld terminal 5 accepts the table number and the number of people that are inputted, in correlation with each other, then generates new order data with a new slip number assigned, and transmits the order data to the order management device 1. The handheld terminal 5 need not necessarily be a dedicated terminal device and can be configured using a general-purpose portable terminal or tablet terminal.

In this embodiment, customers who place orders collectively handled with the same slip number are referred to as a group. A group is formed by one or more customers. That is, the number of people in a customer group is not limited to a plural number and may be one.

On receiving an order from a customer, a staff member (operator) inputs the table number of the customer, the ordered menu item, and the number of servings ordered, to the handheld terminal 5. The handheld terminal 5 inquires the order data from the order management device 1, based on the table number, and receives the order data corresponding to the table number from the order management device 1. The handheld terminal 5 updates the received order data with the menu item and the number of servings ordered whose input is accepted, and transmits the updated order data to the order management device 1.

The self-service ordering terminal 6 is installed, for example, at each table or seat used by a customer for eating and drinking. The self-service ordering terminal 6 is an example of a table terminal used by a customer for ordering an item and functions as an order input device that generates order data. When guided to a vacant table, a customer inputs the number of people in the customer's own group (customer group) to the self-service ordering terminal 6 installed at the table. On accepting the input of the number of people, the self-service ordering terminal 6 generates new order data with a new slip number assigned, in correlation with the table number of the table where this self-service ordering terminal 6 is installed, and then transmits the order data to the order management device 1.

When placing an order, the customer inputs the menu item to order and the number of serving ordered, to the self-service ordering terminal 6. The self-service ordering terminal 6 inquires the order data from the order management device 1, based on the table number of the table where this self-service ordering terminal 6 is installed, and receives the order data corresponding to the table number from the order management device 1. The self-service ordering terminal 6 updates the received order data with the menu item and the number of servings ordered whose input is accepted, and transmits the updated order data to the order management device 1.

The kitchen printer 4 is an example of a terminal device used by the staff and is installed in a cooking space (kitchen or cookery). On receiving an instruction to print slip data from the order management device 1, the kitchen printer 4 starts print processing to print a kitchen slip, based on the slip data. In the cooking space, the staff prepares the ordered menu item, based on the kitchen slip. The floor attendant staff serves the prepared dish to the table of the table number described in the kitchen slip.

The POS terminal 2 is an example of a terminal device used by the staff and is installed at a checkout counter or the like. At the time of payment, the POS terminal 2 inquires the latest slip data of the total for one payment corresponding to a payment target slip number, from the order management device 1, and receives slip data including the total amount of payment for this payment from the order management device 1. The POS terminal 2 executes payment processing based on the received slip data and transmits and outputs transaction data including a notification of completion of payment, the amount of sales, the amounts of deposit and withdrawal, and the like, to the order management device 1. The POS terminal 2 in this embodiment also prints a receipt slip showing details of the order and the payment processing, based on the slip data received from the order management device 1 and the result of the payment processing.

An example of the configuration of the handheld terminal 5 and the order management device 1 will now be described.

FIG. 2 shows an example of the hardware configuration of the handheld terminal 5. As shown in FIG. 2, the handheld terminal 5 has computer components such as a CPU (central processing unit) 51, a ROM (read-only memory) 52, and a RAM (random-access memory) 53.

The CPU 51 is an example of a processor installed in the handheld terminal 5. The CPU 51 manages and controls each part of the handheld terminal 5. The ROM 52 stores various programs. The RAM 53 is a work space where a program or various data are loaded.

The handheld terminal 5 also has a communication unit 54, a memory unit 55, a display unit 56, and an operation unit 57.

The communication unit 54 is a communication interface that can be connected to the network 9. The communication unit 54 communicates with an external device such as the order management device 1 via the access point 3 and the network 9.

The memory unit 55 has a storage medium such as a flash memory and maintains the stored content even if the power is cut off. The memory unit 55 stores various programs executable by the CPU 51 and setting information (not illustrated).

The display unit 56 is a display device such as an LCD (liquid crystal display) and displays various kinds of information and screens under the control of the CPU 51. The operation unit 57 is formed by a touch panel or various operation keys provided on the surface of the display unit 56 and outputs an operation content corresponding to a user's operation to the CPU 51.

The POS terminal 2, which is a terminal device used by the staff, has a display unit 26 and an operation unit 27. The self-service ordering terminal 6, which is a table terminal used by the customer for ordering an item, has a display unit 66 and an operation unit 67. The display units 26, 66 have a function similar to the display unit 56 of the handheld terminal 5. The operation units 27, 67 have a function similar to the operation unit 57 of the handheld terminal 5. That is, the display unit 26 displays various kinds of information and screens under the control of a CPU provided in the POS terminal 2. The operation unit 27 outputs an operation content corresponding to a user's operation to the CPU provided in the POS terminal 2. Similarly, the display unit 66 displays various kinds of information and screens under the control of a CPU provided in the self-service ordering terminal 6. The operation unit 67 outputs an operation content corresponding to a user's operation to the CPU provided in the self-service ordering terminal 6.

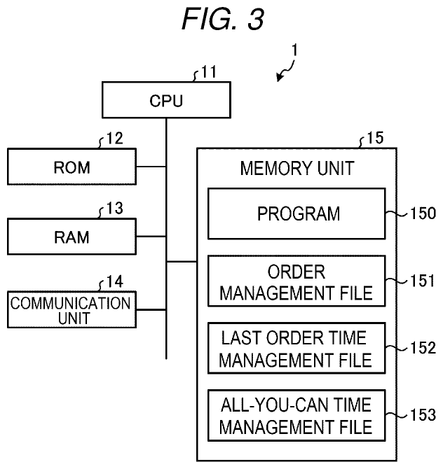

FIG. 3 shows an example of the hardware configuration of the order management device 1. As shown in FIG. 3, the order management device 1 has computer components such as a CPU 11, a ROM 12, and a RAM 13.

The CPU 11 is an example of a processor installed in the order management device 1. The CPU 11 manages and controls each part of the order management device 1. The ROM 12 stores various programs. The RAM 13 is a work space where a program or various data are loaded.

The order management device 1 also has a communication unit 14 and a memory unit 15.

The communication unit 14 is a communication interface that can be connected to the network 9. The communication unit 14 executes communication with an external device such as the POS terminal 2, the kitchen printer 4, the handheld terminal 5, and the self-service ordering terminal 6 via the network 9.

The memory unit 15 has a storage medium such as an HDD (hard disk drive), an SSD (solid-state drive) or a flash memory and maintains the stored content even if the power is cut off. The memory unit 15 stores various programs 150 executable by the CPU 11 and setting information (not illustrated). The memory unit 15 also stores an order management file 151, a last order time management file 152, and an all-you-can time management file 153.

The order management file 151 is a data table for storing and managing order data transmitted from the handheld terminal 5 or the self-service ordering terminal 6. For example, the order management file 151 stores items such as slip number, table number, number of people, total amount, and content of order, as the slip data.

As the slip number, the slip number assigned by the handheld terminal 5 or the self-service ordering terminal 6 is registered. The slip number also functions as identification information for identifying the slip data stored in the order management file 151. The table number is identification information for identifying each table in the shop. The number of people is the number of people in a customer group seated at the table corresponding to the table number. The total amount is the total amount for the menu items ordered.

The content of order includes order information about each menu item that is ordered. The order information includes the name of the menu item, the number of servings, the unit price, and the like. The name of the menu item is the name of the menu item ordered by the customer at the shop. The number of servings is the number of servings of the menu item ordered by the customer at the shop. The unit price is the unit price of the menu item ordered by the customer at the shop.

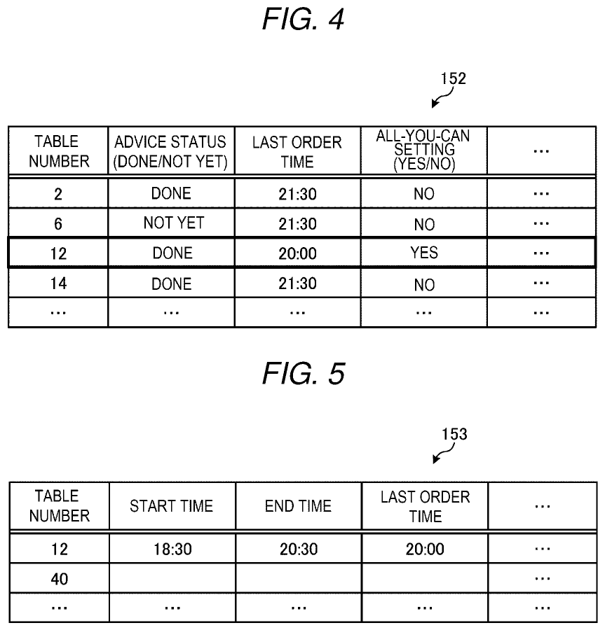

FIG. 4 shows an example of the information stored in the last order time management file 152. The last order time management file 152 sores items such as table number, advice status, last order time, and all-you-can setting. The advice status is information representing whether the last order is already placed or not. The all-you-can setting is information representing whether an all-you-can-drink option or an all-you-can-eat option is set for the table number stored in this record.

FIG. 5 shows an example of the information stored in the all-you-can time management file 153. The all-you-can time management file 153 stores items such as table number, start time, end time, and last order time. The start time is the time when an all-you-can-drink option or an all-you-can-eat option is set (that is, an item from the all-you-can menu is ordered). The end time is the time when a time limit (for example, two hours) defined for the all-you-can menu was passed since the start time. The last order time is a time point that is a predetermined time (for example, 30 minutes) before the end time.

In the following description of this embodiment, in order to simplify the description, it is assumed that one group is seated at one table. However, in practice, there is a case where customers of the same group may be separately seated at a plurality of tables. To deal with this case, the order management file 151 may register a plurality of table numbers in correlation with the same slip number. On the other hand, to cope with a case where a plurality of groups are seated at the same table number, a plurality of slip numbers correlated with the same table number may exist in the order management file 151. That is, in these cases, a record is specified based on the combination of the table number and the slip number in the order management file 151. Also, in a shop where a table and a group may not necessarily coincide with each other, as described above, the slip number may be used instead of the table number, in order to manage the records stored in the last order time management file 152 or the all-you-can time management file 153.

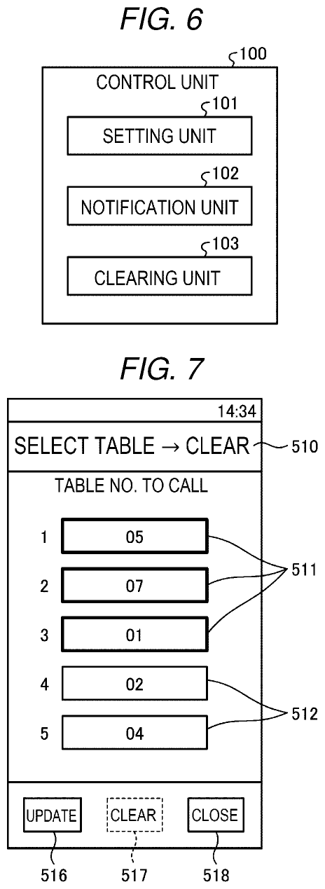

The CPU 11 of the order management device 1 having such a configuration executes the program stored in the ROM 12 or the memory unit 15, thus functions as a control unit 100, and implements various functional units described below with reference to FIG. 6.

FIG. 6 is a block diagram showing an example of the functional units provided in the control unit 100 of the order management device 1. The control unit 100 functions as a setting unit 101, a notification unit 102, and a clearing unit 103.

The setting unit 101 sets the last order time on a per group basis, a group being formed by one or more customers. In this embodiment, the setting unit 101 sets the last order time in correlation with the table number.

More specifically, the setting unit 101 sets one of a time point that is a predetermined time before the closing time of the shop and a time point when a predetermined time limit passed since the start time of the all-you-can-drink option or the all-you-can-eat option, as the last order time, according to the form of ordering applied to the group.

A specific example of the above operation is as follows. When the initial order (first order) is inputted after a group is seated, the setting unit 101 adds a new record to the last order time management file 152. If the group orders an item from the all-you-can menu, the setting unit 101 adds a new record to the all-you-can time management file 153 and updates the last order time in the record of the group in the last order time management file 152, with the last order time in the new record.

The notification unit 102 notifies the handheld terminal 5 of a table number for which the remaining time to the last order time became shorter than a predetermined threshold. The predetermined threshold is approximately zero to five minutes, for example. An appropriate value is set according to the operation of the shop. If the threshold is two minutes, for example, the notification unit 102 notifies the handheld terminal 5 of a table number for which the remaining time to the last order time became shorter than two minutes, as a last order advice target. If the threshold is zero minutes, the notification unit 102 notifies the handheld terminal 5 of a table number for which the last order time already came, as a last order advice target.

The notification unit 102 gives the notification via a display on a notification screen 510. The notification unit 102 generates a list of table numbers that are last order advice targets to be displayed on the notification screen 510.

FIG. 7 shows an example of the notification screen 510 displaying a list of last order advice targets. The notification screen 510 is a screen that the notification unit 102 causes the display unit 56 of the handheld terminal 5 to display. If the order management system includes a plurality of handheld terminals 5, the notification screen 510 is displayed at all the handheld terminals 5.

The notification screen 510 is a screen displayed as a so-called pop-up and is superimposed on the screen currently displayed at the handheld terminal 5. The notification screen 510 shows table numbers 511, 512 of last order advice targets in such a way that a selection operation is acceptable, for example, in the form of buttons. A table number is an example of seating information that can specify a table occupied by a group.

The first to third table numbers 511 in the list shown in the notification screen 510 are the table numbers of tables for which the last order time passed. These table numbers 511 are shown in order from the longest time past the last order time. It is even more preferable to surround these table numbers 511 with a bold frame line or show these table numbers 511 in red in order to attract attention or express urgency. Also, it is effective to show these table numbers 511 with a color gradient such that the color is the darkest shade at the first table number and becomes lighter shades toward the third table number, in order to make the degree of urgency more visible.

The fourth and fifth table numbers 512 shown in the notification screen 510 are the table numbers of tables for which the last order time comes shortly (for example, in one or two minutes).

The notification screen 510 also has an update button 516, a clear button 517, and a close button 518.

The update button 516 is an example of an operating element that is displayed along with the list of last order advice targets and that accepts an instruction to update the tables numbers shown in the list to the latest state. If the update button 516 is operated, the notification unit 102 causes the notification screen 510 to be reloaded. That is, the notification unit 102 re-acquires the information in the last order time management file 152 and causes the notification screen 510 to be re-displayed, based on the re-acquired information. This is an operation for updating the display content of the notification screen 510 to the latest state. For example, there is a case where the advice status (done/not yet) in the last order time management file 152 is changed by an input at another handheld terminal 5 or the self-service ordering terminal 6 after the notification screen 510 is displayed. In this case, the display content of the notification screen 510 changes between before and after the update button 516 is operated.

The clear button 517 accepts an instruction to clear a selected one of the table numbers 511, 512. The clear button 517 is operable when at least one of the table numbers 511, 512 is selected. The close button 518 is a button for closing the notification screen 510 superimposed on the previous screen and returning to the screen for accepting an order or the like.

Referring back to FIG. 6, the clearing unit 103 accepts a clearing of the notification by the notification unit 102 from the handheld terminal 5 or the self-service ordering terminal 6. Specifically, if the clear button 517 is operated in the notification screen 510, the clearing unit 103 receives a signal to that effect and deletes the record corresponding to the table number 511, 512 selected as a clearing target, from the last order time management file 152. The clearing unit 103 also causes the notification screen 510 displayed at the handheld terminal 5 to be reloaded. Thus, the foregoing table number 511, 512 selected as the clearing target is erased from the list shown in the notification screen 510.

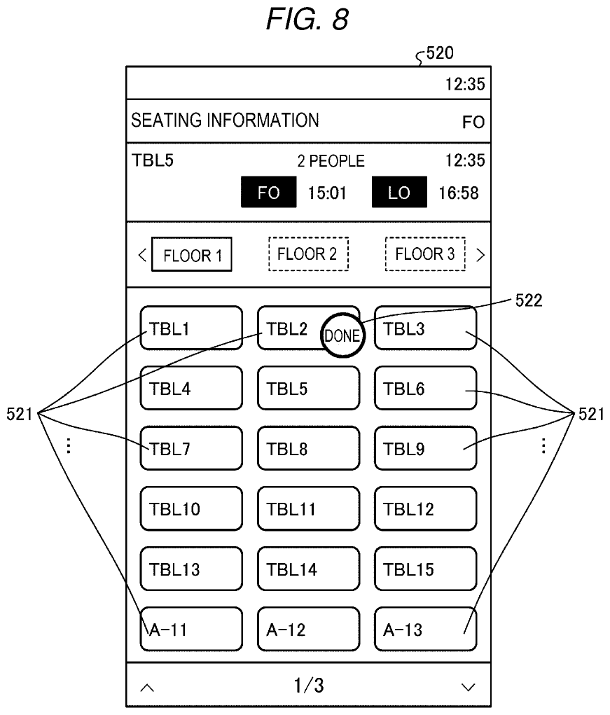

Another characteristic screen displayed at the handheld terminal 5 will now be described. FIG. 8 shows an example of a seating information screen 520 displayed by the display unit 56 of the handheld terminal 5. In the seating information screen 520, table numbers 521 are arranged, for example, in the form of a matrix of buttons in such a way that a selection operation is acceptable, and information (seating information) corresponding to a selected table number 521 is shown, for example, at an upper part of the screen. The seating information is, for example, the number of people corresponding to the customers (group) occupying the seats, the first order time, the last order time, and the like. Via this screen, one can grasp the stay status of the customers (group) at each table.

In the seating information screen 520, the color of the buttons showing the table numbers 521 may be changed according to the duration of the stay time or may be made to correspond to the table numbers 511, 512 in the notification screen 510 shown in FIG. 7.

In the seating information screen 520, if the advice status stored in the last order time management file 152 is “done”, a mark showing that the customers at the table are “already advised” in a visually recognizable manner is attached to the corresponding table number 521. The mark is information formed by, for example, a predetermined character, geometric shape, pattern, picture, symbol, sign or the like.

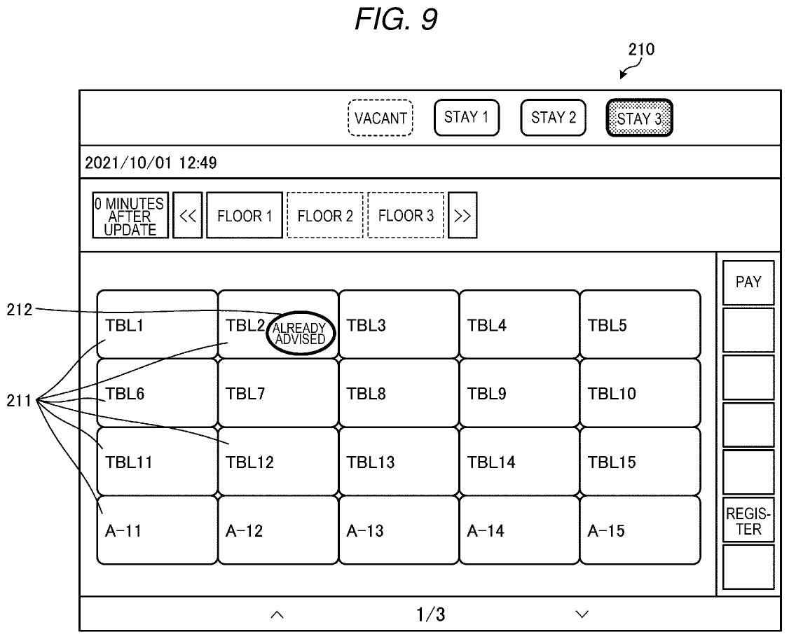

A screen corresponding to the above seating information screen 520 can also be displayed at the POS terminal 2. FIG. 9 shows an example of a seating information screen 210 displayed by the display unit 26 of the POS terminal 2. In the seating information screen 210, table numbers 211 are arranged in the form of a matrix.

In the seating information screen 210, too, a mark showing that the customers at the table are “already advised” in a visually recognizable manner is attached to a table number 211 for which the advice status stored in the last order time management file 152 is “done”. In this case, too, the mark is information formed by, for example, a predetermined character, geometric shape, pattern, picture, symbol, sign or the like.

In the seating information screen 210, too, the color of the buttons showing the table numbers 211 may be changed according to the duration of the stay time or may be made to correspond to the table numbers 511, 512 in the notification screen 510 shown in FIG. 7.

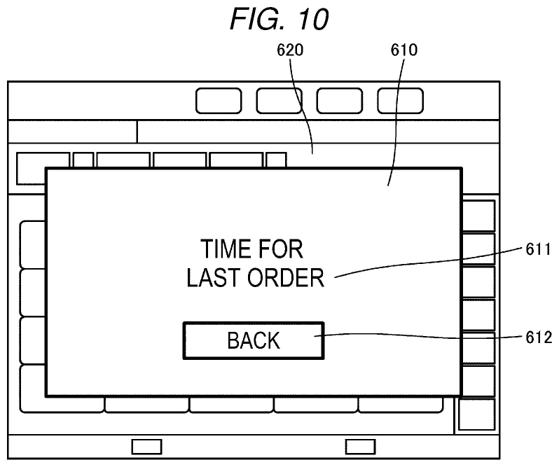

The operation of the notification unit 102 will now be described additionally. The notification unit 102 gives a notification that the last order time is approaching, to the self-service ordering terminal 6 provided at the table of a group whose remaining time to the last order time became shorter than the predetermined threshold. Specifically, the notification unit 102 causes the self-service ordering terminal 6 to display a notification screen 610 described below and shown in FIG. 10. On receiving information to the effect that the notification was confirmed from the self-service ordering terminal 6, the notification unit 102 updates the content of the notification to the handheld terminal 5 (updates the notification screen 510).

FIG. 10 shows an example of the notification screen 610 displayed at the self-service ordering terminal 6. The notification unit 102 causes the display unit 66 of the self-service ordering terminal 6 installed at the advice target table to display the notification screen 610, along with the notification to the handheld terminal 5. The notification screen 610 is a screen displayed as a so-called pop-up and is superimposed on a screen 620 currently displayed at the self-service ordering terminal 6 (for example, a menu screen displaying information about items that are available for order).

The notification screen 610 includes a message 611 of “Time for last order”, for example, and a button (back button) 612 where “Back” is written. If the back button 612 is operated, a signal indicating that the customers (group) at the table was already advised about the last order is transmitted from the self-service ordering terminal 6 to the order management device 1. On receiving this signal, the control unit 100 of the order management device 1 updates the advice status in the corresponding record in the last order time management file 152 to “done”.

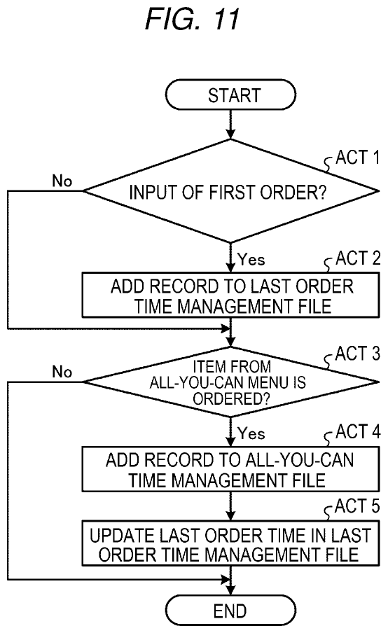

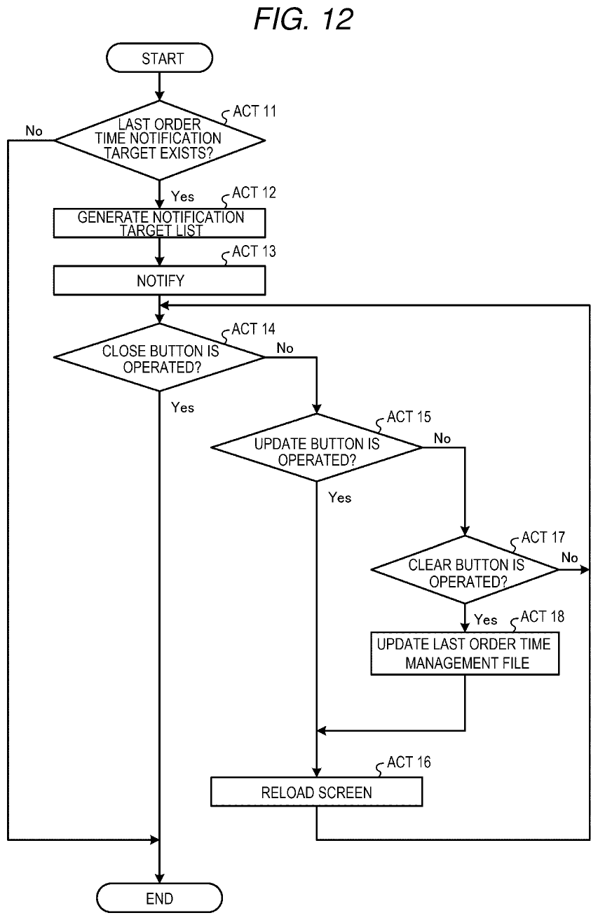

In the order management system as described above, the control unit 100 of the order management device 1 operates as in examples shown in FIGS. 11 and 12.

FIG. 11 is a flowchart explaining an example of a flow of processing executed by the control unit 100 as the setting unit 101. The control unit 100 executes this processing when accepting an input of any order.

If the order whose input is accepted is the first order (Yes in ACT 1), the control unit 100 adds a new record corresponding to this order to the last order time management file 152 (ACT 2).

If an item from an all-you-can menu is ordered (Yes in ACT 3), the control unit 100 adds a new record corresponding to this order to the all-you-can time management file 153 (ACT 4). Subsequently, the control unit 100 updates a record in the last order time management file 152 corresponding to the record added in ACT 4 (ACT 5). That is, the control unit 100 updates the last order time of a record storing the same table number as the record added in ACT 4, of the records in the last order time management file 152, with the last order time in the record added in ACT 4.

If the order whose input is accepted is not the first order in ACT 1 (No in ACT 1), the control unit 100 advances the processing to ACT 3. If an item from the all-you-can menu is not ordered or the order whose input is accepted is not for an item from the all-you-can menu in ACT 3 (in both cases, No in ACT 3), the control unit 100 ends this processing.

FIG. 12 is a flowchart explaining an example of a flow of processing executed by the control unit 100 as the notification unit 102 and the clearing unit 103. The control unit 100 checks whether a table number that should be reported as a last order time advice target exists or not, for example, periodically referring to the last order time management file 152 (ACT 11). If a table number that is a last order time notification target does not exist (No in ACT 11), the control unit 100 ends this processing.

If a table number that is a last order time notification target exists in ACT 11 (Yes in ACT 11), the control unit 100 generates a notification target list (ACT 12) and causes the handheld terminal 5 to display the notification screen 510 giving a notification of this list (ACT 13). If the self-service ordering terminal 6 is installed at the notification target table, the self-service ordering terminal 6 is made to display the notification screen 610 giving a notification that the last order time is coming, in ACT 13.

Next, the control unit 100 monitors the operation status of each button (close button 518, update button 516, clear button 517, back button 612) (ACTs 14, 15 17).

If the close button 518 is operated (Yes in ACT 14), the control unit 100 ends this processing. Next, if the update button 516 is operated (No in ACT 14 and Yes in ACT 15), the control unit 100 reloads the notification screen 510 (ACT 16) and returns the processing to ACT 14. If the clear button 517 (or the back button 612) is operated (No in ACT 15 and Yes in ACT 17), the control unit 100 executes update to delete the target record from the last order time management file 152 (ACT 18) and advances the processing to ACT 16. If no button is operated (No in ACT 17), the control unit 100 returns the processing to ACT 14.

In the related-art system, if a notification that the time for the last order is approaching is delayed, the last order is accepted later than prescribed and therefore the time limit is extended in practice, which is inconvenient. Also, if information about whether the last order was already taken or not is not shared among the staff, an inconvenience arises, for example, at a table where the last order was already taken by one staff member, another staff member may take the last order again. However, according to this embodiment, as described above, at a time point when the centrally managed last order time is approaching (or passed), information to that effect is given at the handheld terminal 5 or the self-service ordering terminal 6. Therefore, the inconvenience of delayed last order advice can be made less likely to occur. That is, this embodiment can support the suggestion of the timing of taking the last order and the sharing of whether the last order was taken or not.

The program executed by each device in the above embodiment is stored in the ROM or the like in advance and provided in this form. The program executed by each device in the above embodiment may be recorded as a file in an installable format or an executable format in a computer-readable recording medium such as a CD-ROM, flexible disk (FD), CD-R, or DVD (digital versatile disk), and provided in this form.

The program executed by each device in the above embodiment may be stored on a computer connected to a network such as the internet and may be downloaded via the network and thus provided. The program executed by each device in the above embodiment may also be provided or distributed via a network such as the internet.

While certain embodiments have been described, these embodiments are presented simply as examples and are not intended to limit the scope of the present disclosure. These novel embodiments can be carried out in various other forms and can include various omissions, replacements, and modifications without departing from the spirit and scope of the present disclosure. These embodiments and the modifications thereof are included in the spirit and scope of the present disclosure and also included in the scope of the claims and equivalents thereof.

What is claimed is:

1. An information processing device, comprising:
a setting component configured to set a last order time on a per group basis, a group comprising one or more customers;
a notification component configured to notify a terminal device used by staff of seating information that specifies a table occupied by the group whose remaining time to a last order time is shorter than a predetermined threshold; and
a clearing component configured to accept a clearing of the notification by the notification component, from the terminal device.

2. The information processing device according to claim 1, wherein
the notification component causes a display of the terminal device to display the seating information as a selectable list, and
the clearing component erases selected seating information, of the seating information, from the selectable list.

3. The information processing device according to claim 2, wherein
the notification component causes the display to further display an operating element configured to accept an instruction to update the seating information displayed in the selectable list to a latest state, along with the selectable list.

4. The information processing device according to claim 1, wherein
the notification component
gives a notification that the last order time is approaching to a table terminal provided at a table of a group whose remaining time to the last order time is shorter than the predetermined threshold, the table terminal used by a customer for ordering an item, and
updates a content of notification to the terminal device if the notification component accepts information that the notification is confirmed from the table terminal.

5. The information processing device according to claim 1, wherein
the setting component sets one of a time point when a predetermined time limit passes since a start time and a time point that is a predetermined time before a closing time of the shop and, as the last order time, according to a form of ordering applied to the group.

6. The information processing device according to claim 1, wherein
the information processing device is a hand-held device.

7. An information processing method, comprising:
setting a last order time on a per group basis, a group comprising one or more customers;
notifying a terminal device used by staff of seating information that specifies the group whose remaining time to a last order time is shorter than a predetermined threshold; and
accepting a clearing of the notification, from the terminal device.

8. The information processing method according to claim 7, wherein
the notification component causes a display of the terminal device to display the seating information as a selectable list, and
the clearing component erases selected seating information, of the seating information, from the selectable list.

9. The information processing method according to claim 8, wherein
the notification component causes the display to further display an operating element configured to accept an instruction to update the seating information displayed in the selectable list to a latest state, along with the selectable list.

10. The information processing method according to claim 7, wherein
the notification component
gives a notification that the last order time is approaching to a table terminal provided at a table of a group whose remaining time to the last order time is shorter than the predetermined threshold, the table terminal used by a customer for ordering an item, and
updates a content of notification to the terminal device if the notification component accepts information that the notification is confirmed from the table terminal.

11. The information processing method according to claim 7, wherein
the setting component sets one of a time point when a predetermined time limit passes since a start time and a time point that is a predetermined time before a closing time of the shop and, as the last order time, according to a form of ordering applied to the group.

12. An order management system, comprising:
a POS terminal to execute payment processing;
a self-ordering terminal;
information processing device, comprising:
a setting component configured to set a last order time on a per group basis, a group comprising one or more customers;
a notification component configured to notify a terminal device used by staff of seating information that specifies a table occupied by the group whose remaining time to a last order time is shorter than a predetermined threshold; and
a clearing component configured to accept a clearing of the notification by the notification component, from the terminal device; and
a network connected to each of the self-ordering terminal, the POS terminal, and the information processing device.

13. The order management system according to claim 12, wherein in the information processing device,
the notification component causes a display of the terminal device to display the seating information as a selectable list, and
the clearing component erases selected seating information, of the seating information, from the selectable list.

14. The order management system according to claim 13, wherein in the information processing device,
the notification component causes the display to further display an operating element configured to accept an instruction to update the seating information displayed in the selectable list to a latest state, along with the selectable list.

15. The order management system according to claim 12, wherein in the information processing device,
the notification component
gives a notification that the last order time is approaching to a table terminal provided at a table of a group whose remaining time to the last order time is shorter than the predetermined threshold, the table terminal used by a customer for ordering an item, and
updates a content of notification to the terminal device if the notification component accepts information that the notification is confirmed from the table terminal.

16. The order management system according to claim 12, wherein in the information processing device,
the setting component sets one of a time point when a predetermined time limit passes since a start time and a time point that is a predetermined time before a closing time of the shop and, as the last order time, according to a form of ordering applied to the group.

17. The order management system according to claim 12, wherein the information processing device is a hand-held device.

18. The order management system according to claim 12, wherein in the self-ordering terminal,
a second notification component configured to notify the self-ordering terminal whose remaining time to the last order time is shorter than a predetermined threshold; and
a second clearing component configured to accept a clearing of the notification by the second notification component, from the self-ordering terminal.

19. The order management system according to claim 18, wherein in the self-ordering terminal,
the second notification component causes a second display of the self-ordering terminal to display the seating information as a selectable list, and
the second clearing component erases selected seating information, of the seating information, from the selectable list.

20. The order management system according to claim 12, wherein
The network is a wireless network.
